(19) United States
(12) Patent Application Publication
(10) Pub. No.: US 2008/0309610 A1
(43) Pub. Date: Dec. 18, 2008

(54) IMAGE DISPLAY DEVICE

(75) Inventors: Tomonori Yoshida, Osaka (JP); Yoshinori Wanaka, Lowestoft (GB); Kunihiko Miki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/137,707

(22) Filed: Jun. 12, 2008

(30) Foreign Application Priority Data
Jun. 13, 2007 (JP) 2007-155822

(51) Int. Cl. G09G 3/36

(52) U.S. Cl. 345/102

(57) ABSTRACT

An image display device has: a display 4 for displaying a video image; a backlight 3 for illuminating the display 4; a level detector 6 for detecting level of a video signal; a video signal adjuster 5 for adjusting a video signal to a signal of a level adapted to be displayed by the display 4; and a microcomputer 1, based on a signal from the level detector 6, for decreasing illuminance of the backlight 3 when the level of the video signal is low and increasing illuminance of the backlight 3 when the level of the video signal is high. The microcomputer 1 has a timer function and has a correcting function, when the low level of the video signal detected by the level detector 6 continues more than predetermined time, for increasing one of the level of the video signal and a brightness level of the display 4 by controlling the video signal adjuster 5.

### BACKGROUND OF THE INVENTION

1. Field of the Invention

The present invention relates to an image display device for displaying an image while illuminating a liquid crystal panel by a backlight.

2. Description of the Related Art

Hitherto, an image display device for displaying an image on a liquid crystal display as a liquid crystal panel is known. As shown in FIG. 7, the image display device illuminates a liquid crystal display (4) from the side opposite to the display surface of the liquid crystal display (4) by a backlight (3). As an image display device of this kind, an apparatus for detecting the amplitude level of an image signal and variably setting illuminance of the backlight (3) is known (refer to Japanese Unexamined Patent Application Publication No. 2004-157559). An image display device having a so-called dynamic backlight function using the known apparatus has been proposed.

In the apparatus, by increasing the illuminance of the backlight in a light scene and decreasing the illuminance of the backlight in a dark scene, the illuminance difference between the light scene and the dark scene is increased. As a result, a stronger image is projected.

Concretely, to the backlight (3) shown in FIG. 7, pulses P having a duty ratio are supplied. FIG. 8 is a graph showing the relation between the video signal input level and brightness of the liquid crystal display (4) in the case where the modulated-light duty cycle is 100% and the case where the modulated-light duty cycle is 40%. In the graph of FIG. 8, in the case where the video signal input level is 100% and 0% at the modulated-light duty cycle of 100%, the brightness of the liquid crystal display (4) is 500 cd/m² and 1.0 cd/m², respectively, and the contrast is 500:1. Also in the casewhere the modulated-light duty cycle is 40%, the brightness of the liquid crystal display (4) is 250 cd/m² and 0.5 cd/m², respectively, and the contrast is 500:1.

When the dynamic backlight function is operated, the illuminance of the backlight (3) can be changed according to the level of an image signal. Concretely, as shown in the graph of FIG. 9, the modulated-light duty cycle is set directly proportional to the video signal input level so that the modulated-light duty cycle becomes 40% when the video signal input level is 0% and the modulated-light duty cycle becomes 100% when the video signal input level is 75% or higher.

By operating the dynamic backlight function, as shown in FIG. 10, in the case where the video signal input level is 100% at the modulated-light duty cycle of 100%, the brightness of the liquid crystal display (4) is unchanged and is 500 cd/m². However, in the case where the video signal input level is 0%, the brightness of the liquid crystal display (4) becomes 0.5 cd/m² which is lower than that in the case where there is no dynamic backlight function. That is, the contrast increases to 1000:1. As a result, the contrast in an image, particularly, in a motion picture increases, and a strong video image can be provided.

The contrast is effective for a moving picture in which the input level of a video signal changes all the time but is not so effective in a picture plane in which the input level of a video signal hardly changes. For example, in a scene such that characters are displayed weakly in a black background, the video signal level in the scene is close to 0%. Consequently, by the dynamic backlight function, the brightness of the backlight (3) is dropped to about the minimum, and the characters are not easily seen. Further, in a video image close to a still picture in which dark scenes continue, the effect of the dynamic backlight function is low and, rather, the viewability of an image is lower.

### SUMMARY OF THE INVENTION

The present invention is to prevent a problem of low viewability even when video images of low signal level continue in an image display device having a dynamic backlight function.

An image display device has: a display (4) for displaying a video image; a backlight (3) for illuminating the display (4); a level detector (6) for detecting level of a video signal; a video signal adjuster (5) for adjusting a video signal to a signal of a level adapted to be displayed by the display (4); and a control circuit, based on a signal from the level detector (6), for decreasing illuminance of the backlight (3) when the level of the video signal is low and increasing illuminance of the backlight (3) when the level of the video signal is high. The control circuit has a timer function and has a correcting function, when the low level of the video signal detected by the level detector (6) continues more than predetermined time, for increasing one of the level of the video signal and a brightness level of the display (4) by controlling the video signal adjuster (5).

In the case where the so-called dynamic backlight function is operated, when the level of a video signal is low, the control circuit decreases the illuminance of the backlight (3). However, when the low level of the video signal detected by the level detector (6) continues more than predetermined time, one of the level of the video signal and the brightness level of the display (4) is increased by controlling the video signal adjuster (5).

In such a manner, even when video images of the low signal level continue, the problem of low viewability can be prevented.

### BRIEF DESCRIPTION OF THE DRAWINGS

FIG. 1 is a block diagram of an image display device;

FIG. 2 is a flowchart showing operations of a microcomputer;

FIG. 3 is a graph showing a general gamma characteristic in the image display device;

FIG. 4 is a diagram explaining a representative point matching method;

FIG. 5 is a block diagram of an image display device having motion detecting means;

FIG. 6 is a flowchart showing operation of a microcomputer;

FIG. 7 is a diagram showing a general configuration of the image display device;

FIG. 8 is a graph showing a brightness characteristic of a liquid crystal panel at modulated-light duty rate;

FIG. 9 is a graph showing a light modulation control in the dynamic backlight function; and

FIG. 10 is a graph showing a brightness characteristic of the liquid crystal panel in the dynamic backlight function.

### DETAILED DESCRIPTION OF PREFERRED EMBODIMENTS

### First Embodiment

An embodiment of the present invention will be described in detail below with reference to the drawings.

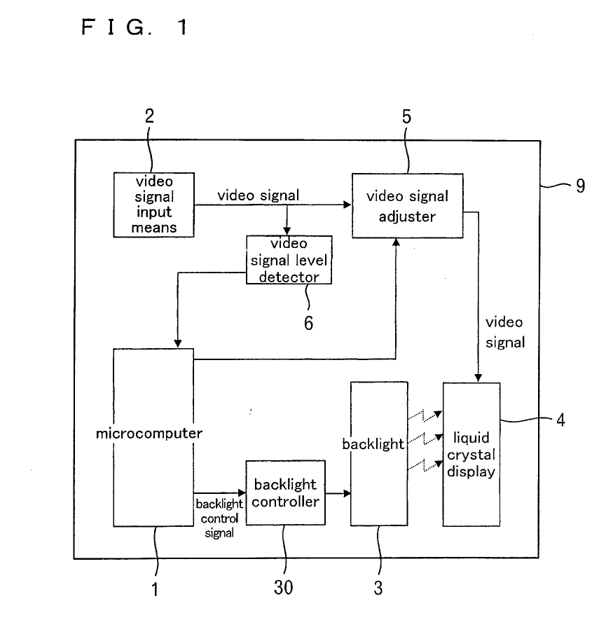

FIG. 1 is a block diagram of an image display device as the embodiment. An input side of video signal input means (2) provided in a cabinet (9) is connected to an antenna (not shown). The video signal input means (2) outputs a video signal which is input to a video signal adjuster (5) for changing gain and a gamma characteristic and a video signal level detector (6) for detecting level of the video signal. Specifically, the video signal adjuster (5) adjusts the video signal to a signal of a level adapted to be displayed by the liquid crystal display (4). The video signal level detector (6) is connected to a microcomputer (1) as a control circuit. The microcomputer (1) controls the video signal adjuster (5) based on the level detected by the video signal level detector (6). The microcomputer (1) is also connected to a backlight controller (30) for controlling illuminance of the backlight (3). Like a conventional technique, the backlight (3) illuminates the liquid crystal display (4) and a video signal from the video signal adjuster (5) is input to the liquid crystal display (4).

As it is known, the microcomputer (1) has therein an operation clock frequency generation source, and can be used as a timer by dividing the clock frequency. As it is known, the microcomputer (1) has a cache memory (not shown). Data for determining lapse of predetermined time t1 is stored in the cache memory.

The dynamic backlight function may be provided in the microcomputer (1). The user may turn on/off the dynamic backlight function by a change-over switch (not shown) provided on the cabinet (9).

By the dynamic backlight function, when the level of the video signal from the video signal input means (2) is high, the microcomputer (1) increases the brightness of the backlight (3) via the backlight controller (30). When the level is low, the microcomputer (1) decreases the brightness of the backlight (3).

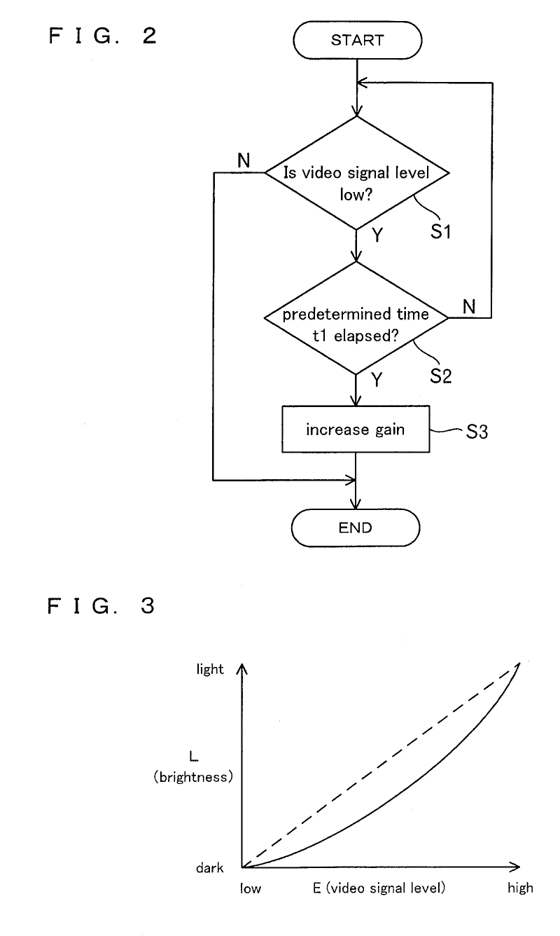

In the example, when the video signal of low level continues more than the predetermined time t1, it is determined that viewability of an image deteriorates because of the dynamic backlight function, and the gain of the video signal to be input to the liquid crystal display (4) is increased. A concrete procedure will be described with reference to the flowchart of FIG. 2.

When the microcomputer (1) determines that the level of the video signal input to the video signal level detector (6) is low, that is, a predetermined level or less (S1), the microcomputer (1) makes the timer function operate and detects whether the video signal of the low level is continuously input for the predetermined time t1 or longer (S2). When the level of the input signal becomes high within the predetermined time t1, there is the possibility that the scene is temporarily dark, so that the video signal process after that is not performed.

When the video signal of the low level is continuously input more than the predetermined time t1, there is the possibility that the viewability of an image deteriorates due to the dynamic backlight function. Therefore, the microcomputer (1) controls the video signal adjuster (5) to increase the gain of the video signal (S3). In such an image display device, by the gamma characteristic which will be described later, when the gain of the video signal is increased and the level of the video signal is increased, the brightness of the video signal also increases. Thus, while avoiding the problem of deterioration in viewability, by the dynamic backlight function, the user can enjoy a strong video image even the level of the image is low.

Instead of increasing the gain of the video signal, the video signal adjuster (5) may decrease the gamma characteristic of the video signal. The gamma characteristic will be described below.

FIG. 3 is a graph showing the general gamma characteristic in the image display device. The longitudinal axis indicates the brightness L in the display (4) and the horizontal axis indicates a video signal level E. The characteristics of the level E of the video signal which is input to the video signal input means (2) and the brightness L are expressed as follows.

L=K×E^{γy} (where K is a constant)

γ denotes a value of about 2.0 to 3.0. The brightness L draws a parabolic curve as shown by the solid line with respect to the video signal level E. When the video signal level E increases, the brightness L also increases. Decrease in the gamma characteristic denotes decrease in the value of γ. As shown by a broken line, the tilt of the brightness L with respect to the video signal level E becomes steep. That is, in the range where the video signal level is low, even when the video signal level E is the same, the brightness L on the display (4) can be increased. With this technique as well, while avoiding the problem that the viewability of a low-level video image deteriorates, a strong video image can be enjoyed by the dynamic backlight function.

The microcomputer (1) may increase the illuminance of the backlight (3) in place of correcting the gain and the gamma characteristic of the video signal. Concretely, by the dynamic backlight function, when a low-level video signal is input, the illuminance of the backlight (3) is decreased. After detection that the low-level video signal is input for the predetermined time t1 or longer, by controlling the backlight controller (30), the illuminance of the backlight (3) maybe reset to the original illuminance.

### Second Embodiment

In a second embodiment, as shown in FIG. 5, the microcomputer (1) is connected to motion detecting means (7) When there is no motion in an image for more than the predetermined time t1, it is determined that the viewability of the image deteriorates due to the dynamic backlight function, and a correction such as increase in the gain of a video signal is performed.

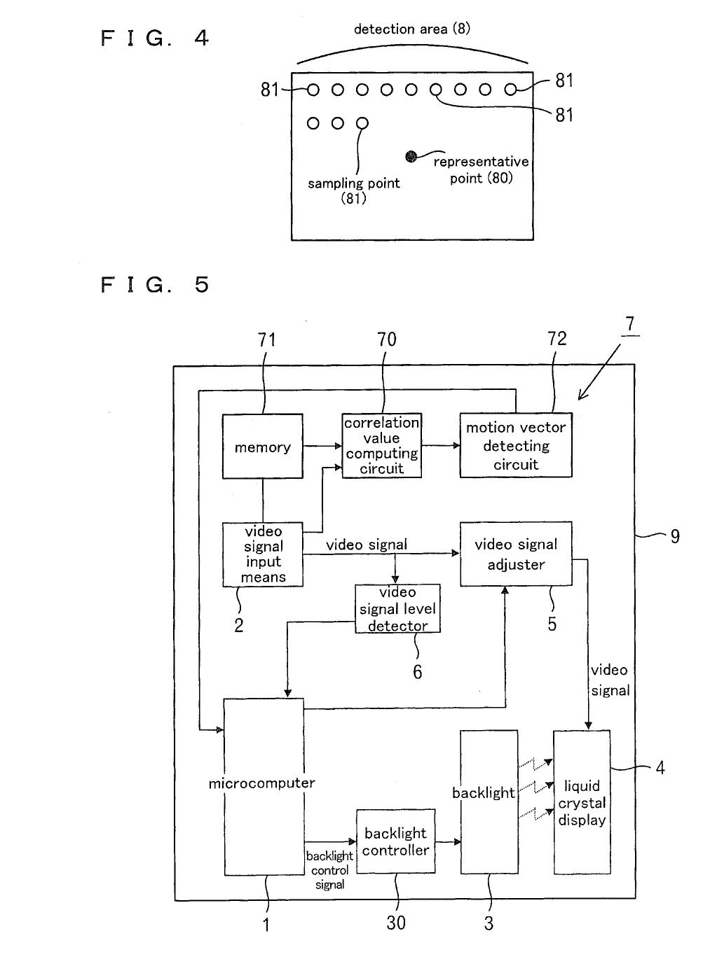

There are various configurations for the motion detecting means (7). As an example, there is a configuration using a representative point matching method. According to the method, a screen is divided and, as shown in FIG. 4, a detection area (8) is provided. In the detection area (8), a representative point (80) and a plurality of sampling points (81) and (81) different from the representative point (80) are provided. The level of a video signal at the representative point (80) in an immediately preceding field and the video signal levels at the sampling points (81) and (81) in the detection area (8) in the present field are compared with each other. The sampling point (81) in the present field having the smallest difference, in other words, high correlation is obtained. The positional difference between the sampling point (81) and the representative point (80) is specified as a motion vector in the image. In place of the video signal in the immediately preceding field, a video signal in the immediately preceding frame may be used.

FIG. 5 is a block diagram of an image display device having the motion detecting means (7). The motion detecting means (7) has a memory (71) for outputting a signal from the video signal input means (2) while delaying the signal only by time of one field, a correlation value computing circuit (70) to which the signal from the video signal input means (2) and the signal from the memory (71) are input, and a motion vector detecting circuit (72) connected to the correlation value computing circuit (70). The correlation value computing circuit (70) computes the sampling point (81) in the present field having the highest correlation with the representative point (80) based on the principle of the representative point matching method. The motion vector detecting circuit (72) obtains a motion vector of an image from the positional difference between the representative point (80) and the sampling point (81) in the present field, and sends a signal of the motion vector to the microcomputer (1).

Therefore, when the microcomputer (1) receives a signal indicating that the motion vector is zero or close to zero from the motion vector detecting circuit (72), it is known that the image is a still image or an image hardly having a motion.

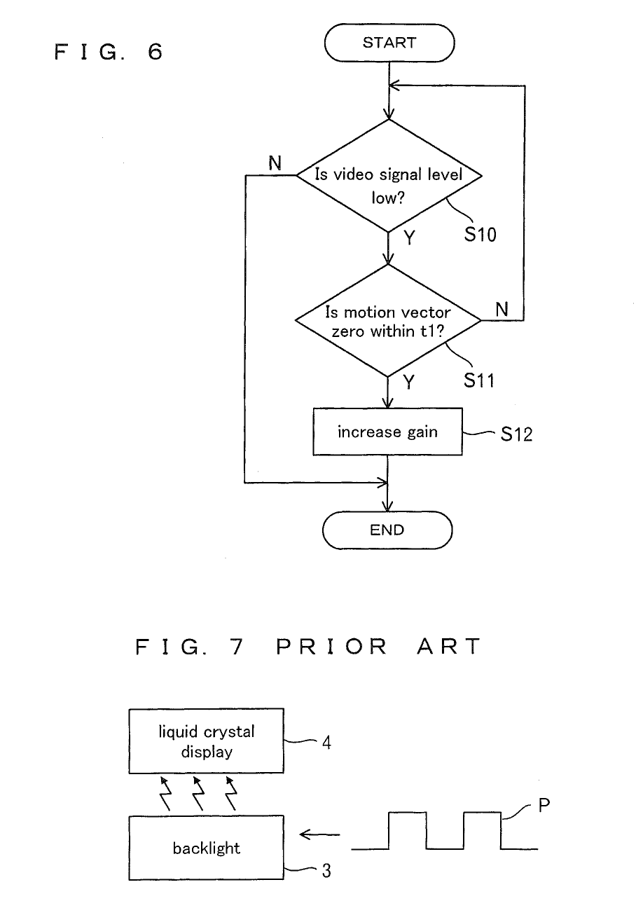

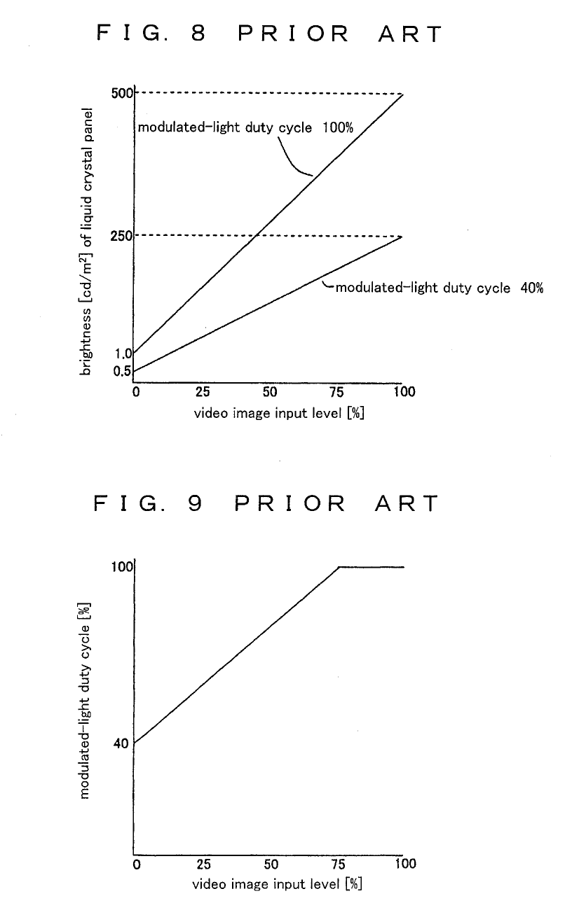

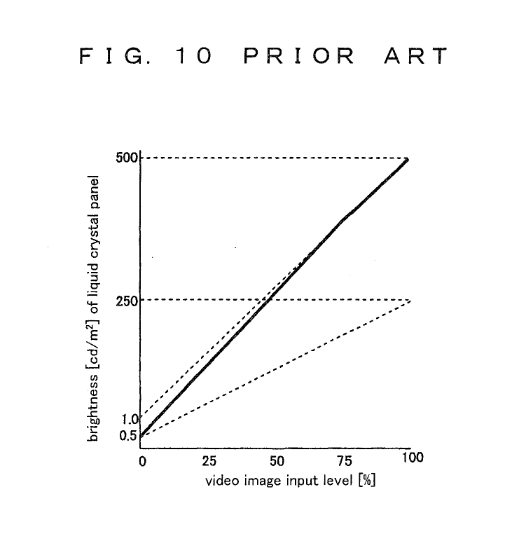

FIG. 6 is a flowchart showing the operation of the microcomputer (1) in the embodiment.

When the microcomputer (1) determines that the level of a video signal input to the video signal level detector (6) is low or equal to a predetermined level or less (S10), the microcomputer (1) makes the timer function operate and measures lapse time. After that, when a signal indicating that the motion vector is zero or close to zero is continuously received from the motion vector detecting circuit (72) within the predetermined time t1 (S11), it is known that the image is a still image or an image hardly having a motion and a low-level video signal is continuously input.

There is consequently the possibility that the dynamic backlight function deteriorates viewability of a video image, so that the microcomputer (1) controls the video signal adjuster (5) to increase the gain of the video signal (S12). Thus, while avoiding a problem that viewability of a low-level image deteriorates, a strong video image can be enjoyed by the dynamic backlight function.

In a manner similar to the first embodiment, in place of increasing the gain of a video signal, the gamma characteristic of the video signal may be decreased or the illuminance of the backlight (3) may be increased to the original state.

What is claimed is:

1. An image display device comprising:
a display for displaying a video image;
a backlight for illuminating the display;
a level detector for detecting level of a video signal;
a video signal adjuster for adjusting a video signal to a signal of a level adapted to be displayed by the display; and
a control circuit, based on a signal from the level detector, for decreasing illuminance of the backlight when the level of the video signal is low and increasing illuminance of the backlight when the level of the video signal is high,
wherein the control circuit has a timer function and has a correcting function, when the low level of the video signal detected by the level detector continues more than predetermined time, for increasing one of the level of the video signal and a brightness level of the display by controlling the video signal adjuster.

2. The image display device according to claim 1, wherein when the low level of the video signal detected by the level detector continues more than predetermined time, the control circuit controls the video signal adjuster to increase gain of the video signal or controls a gamma characteristic.

3. An image display device comprising:
a display for displaying a video image;
a backlight for illuminating the display;
a level detector for detecting level of a video signal;
a backlight controller for controlling illuminance of the backlight; and
a control circuit, based on a signal from the level detector, via the backlight controller, for decreasing illuminance of the backlight when the level of the video signal is low and increasing illuminance of the backlight when the level of the video signal is high,
wherein the control circuit has a timer function and has a correcting function, when the low level of the video signal detected by the level detector continues more than predetermined time, for increasing the illuminance of the backlight by controlling the backlight controller.

4. An image display device comprising:
a display for displaying a video image;
a backlight for illuminating the display;
a level detector for detecting level of a video signal;
a video signal adjuster for adjusting a video signal to a signal of a level adapted to be displayed by the display;
a motion detecting means for detecting a motion in an image from the video signal; and
a control circuit, based on a signal from the level detector, for decreasing illuminance of the backlight when the level of the video signal is low and increasing illuminance of the backlight when the level of the video signal is high,
wherein the control circuit is connected to the motion detecting means, and
the control circuit has a timer function and has a correcting function, when the motion detecting means does not detect a motion in an image within predetermined time, for increasing one of the level of the video signal and a brightness level of the display by controlling the video signal adjuster.

5. An image display device comprising:
a display for displaying a video image;
a backlight for illuminating the display;
a level detector for detecting level of a video signal;
a motion detecting means for detecting a motion in an image from the video signal;
a backlight controller for controlling illuminance of the backlight; and
a control circuit, based on a signal from the level detector, via the backlight controller, for decreasing illuminance of the backlight when the level of the video signal is low and increasing illuminance of the backlight when the level of the video signal is high,
wherein the control circuit is connected to the motion detecting means, and
the control circuit has a timer function and has a correcting function, when the motion detecting means does not detect a motion in an image within predetermined time, for increasing the illuminance of the backlight by controlling the backlight controller.
